(19) United States
(12) Patent Application Publication
(10) Pub. No.: US 2026/0338981 A1
(43) Pub. Date: Oct. 29, 2026

(54) A SYSTEM AND METHOD FOR PROVIDING AND EXECUTING STANDARDIZED SEISMIC PROCESSING WORKFLOWS

(71) Applicant: SCHLUMBERGER TECHNOLOGY CORPORATION, Sugar Land, TX (US)

(72) Inventors: Michael BEAM, Houston, TX (US); Fabrice LEVASSOR, Montpellier (FR); Robert BLOOR, Houston, TX (US); Gavin MENZEL-JONES, Houston, TX (US); Marwa ELBADRY, Houston, TX (US); David HALLIDAY, Crawley (GB)

(21) Appl. No.: 19/113,005

(22) PCT Filed: Sep. 18, 2023
(86) PCT No.: PCT/US2023/074475

§ 371 Date: Mar. 19, 2025

Related U.S. Application Data
(60) Provisional application No. 63/376,162, filed on Sep. 19, 2022.

(51) Int. Cl. G01V 1/34

(52) U.S. Cl. CPC G01V 1/345; G01V 2200/14

(57) ABSTRACT

A computing system for providing standardized seismic processing workflows includes a workflow template registry configured to register a plurality of workflow templates that each include one or more steps that produce output seismic data. The computing system also includes a workflow execution track template registry configured to register a plurality of track templates. Each track template includes one or more of the workflow templates. The computing system also includes a workflow execution graphical user interface configured to enable a definition of a seismic processing project. The seismic processing project includes a plurality of tracks and a sequence of seismic processing activities. The computing system also includes a workflow execution dispatcher configured to cause the one or more steps to interact with a cloud computing environment. The computing system also includes an output data registry.

### CROSS-REFERENCE TO RELATED APPLICATIONS

This application claims priority to U.S. Provisional Patent Application No. 63/376,162, filed on Sep. 19, 2022, the entirety of which is incorporated by reference.

### BACKGROUND

Seismic data provides the means for an understanding of the subsurface, through providing an ‘image’ of the subsurface. To generate an accurate image of the subsurface, an estimation of the subsurface properties, including the rock velocities, is performed. More particularly, depth imaging and earth model building are used generate an accurate image of the subsurface, and tomography is used in depth imaging to construct the rock velocities. Tomography, in the context of seismic data processing, is used by service companies and energy operators. Specialist experts in seismic data processing have conventionally run the tomography workflow due to its complexity.

### SUMMARY

A computing system for providing standardized seismic processing workflows is disclosed. The computing system includes a workflow template registry configured to register: a plurality of workflow templates that each include one or more steps that produce output seismic data; a plurality of parameters that are related to the workflow templates; and a plurality of workflow template conditions that are related to the workflow templates. The computing system also includes a workflow execution track template registry configured to register: a plurality of track templates that each include one or more of the workflow templates; and a plurality of track template conditions that are related to the track templates. The computing system also includes a quality control (QC) template registry configured to register a plurality of QC templates that configure a seismic processing data visualization environment. The computing system also includes a workflow execution graphical user interface configured to enable a definition of a seismic processing project. The seismic processing project includes a plurality of tracks and a sequence of seismic processing activities. The computing system also includes a workflow execution dispatcher configured to cause the one or more steps to interact with a cloud computing environment. The computing system also includes an output data registry. Computational processes that are configured by the one or more steps to execute in locations on the cloud computing environment communicate the output seismic data by registering the locations in the output data registry.

In another embodiment, the computing system includes a workflow template registry configured to register a plurality of workflow templates that each include one or more steps. The one or more steps include a seismic processing step that produces output seismic data. The workflow templates include tomography, full waveform inversion (FWI), or both. The workflow template registry is also configured to register a plurality of parameters that are related to the workflow templates. The workflow template registry is also configured to register a plurality of workflow template conditions that are related to the workflow templates. The computing system also includes a workflow execution track template registry configured to register a plurality of track templates. Each track template includes one or more of the workflow templates. The workflow execution track template registry is also configured to register a plurality of track template conditions that are related to the track templates. The track template conditions include one or more of the workflow template conditions. The computing system also includes a quality control (QC) template registry configured to register a plurality of QC templates that configure a seismic processing data visualization environment. The QC templates are associated with the one or more steps in the workflow templates, which provides an ability to display and review the output seismic data and diagnostic data of the seismic processing step in a standardized manner. The computing system also includes a workflow execution graphical user interface configured to enable a definition of a seismic processing project. The seismic processing project includes a plurality of tracks and a sequence of seismic processing activities to achieve an end objective. The tracks are created based upon the track templates and the track template conditions. Each track provides a selection of the workflow templates that have been registered with the workflow template registry. Only the workflow templates in which the track template conditions are met are provided in the selection. The computing system also includes a workflow execution dispatcher configured to cause one or more of the steps to interact with a cloud computing environment. A successful execution of a first workflow step in one or more of the workflow templates automatically triggers an execution of a second workflow step in the one or more of the workflow templates. The successful execution of a first of the one or more workflow templates within one or more of the track templates automatically triggers an execution of a second of the one or more workflow templates within one or more of the track templates. The computing system also includes an output data registry. Computational processes that are configured by the workflow steps to execute in locations on the cloud computing environment communicate the output seismic data by registering the locations in the output data registry.

In another embodiment, the computing system includes a workflow template registry configured to register a plurality of workflow templates that each include one or more steps. The one or more steps include a seismic processing step that produces output seismic data. The workflow templates include defined antecedent or subsequent workflow templates. The workflow templates include tomography, full waveform inversion (FWI), or both. The workflow template registry is also configured to register a plurality of parameters that are related to the workflow templates. The parameters include input data locations, output data locations, and geophysical algorithm parameters. The workflow template registry is also configured to register a plurality of workflow template conditions that are related to the workflow templates. The workflow template conditions include a geological setting, a seismic processing project objective, a seismic processing project data type, and a seismic processing project work scope. The computing system also includes a workflow execution track template registry configured to register a plurality of track templates. Each track template includes one or more of the workflow templates. The workflow execution track template registry is also configured to register a plurality of track template conditions that are related to the track templates. The track template conditions include the geological setting, the seismic processing project objective, the seismic processing project data type, and the seismic processing project work scope. The computing system also includes a quality control (QC) template registry configured to register a plurality of QC templates that configure a seismic processing data visualization environment. The QC templates are associated with the one or more steps in the workflow templates, which provides an ability to display and review the output seismic data and diagnostic data of the seismic processing step in a standardized manner. The computing system also includes a workflow execution graphical user interface configured to enable a definition of a seismic processing project. The seismic processing project includes a plurality of tracks and a sequence of seismic processing activities to achieve an end objective. The tracks are created based upon the track templates and the track template conditions. Each track provides a selection of the workflow templates that have been registered with the workflow template registry and created in a context of the respective track. Only the workflow templates in which the track template conditions are met are provided in the selection. The QC templates configure the workflow execution graphical user interface to present one or more data visualization interfaces. The workflow execution graphical user interface supports viewing the output seismic data in the one or more data visualization interfaces. The workflow execution graphical user interface provides recommendations on the parameters based on displays configured in the QC templates. The output seismic data from a first step of the one or more steps or the parameters from the first step in one or more of the workflow templates are configured to be automatically configured as the parameters for a subsequent step of the one or more steps in the same workflow template as defined by the workflow templates. The computing system also includes a workflow execution dispatcher configured to cause one or more of the steps to interact with one or more cloud computing environments. One or more interfaces and protocols facilitate data to be communicated between the one or more cloud computing environments and the workflow execution graphical user interface. A successful execution of a first workflow step in one or more of the workflow templates automatically triggers an execution of a second workflow step in the one or more of the workflow templates. The successful execution of a first of the one or more workflow templates within one or more of the track templates automatically triggers an execution of a second of the one or more workflow templates within one or more of the track templates. The computing system also includes an output data registry. Computational processes that are configured by the workflow steps to execute in locations on the one or more cloud computing environments communicate the output seismic data by registering the locations in the output data registry. Standardized identifiers are used to correlate the output seismic data to the parameters or the input data locations used in the seismic processing data visualization environment via configuration in one or more of the QC templates, or for use in subsequent workflow steps configured in one or more of the workflow templates.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a schematic view of a full waveform inversion (FWI) workflow, according to an embodiment.

FIG. 5 illustrates an image of a FWI workspace, according to an embodiment. The workspace includes tabs related to input to FWI (e.g., earth properties, seismic, and workflow parameters) along with two FWI aspects-wavelet inversion and full waveform inversion. The FWI workspace also shows different frequencies on the left column from low to high (4 Hz to 20 Hz) for multi-stage iterative FWI execution. This particular display is for 4 Hz inversion frequency. This display also shows the full seismic shot location map from multiple surveys along with an Area of Interest (AOI). The data from the AOI may be used for pilot test(s), and the full survey may be used for production.

FIG. 6 illustrates an image of the FWI workspace including an “earth properties” tab that shows a list of TTI model property files (e.g., Vp, Delta, Epsilon, Dip, and Azimuth), according to an embodiment.

FIG. 7 illustrates an image of the FWI workspace including a “seismic” tab that shows a text file containing location paths of input seismic sail-lines from multiple surveys, according to an embodiment.

FIG. 8 illustrates an image of the FWI workspace showing that a different frequency workflow can be selected (e.g., low to high) by clicking on the left column (e.g., now 20 Hz template is selected), according to an embodiment.

FIG. 9 illustrates an image of the FWI workspace showing how to add a standardized wavelet inversion workflow step for a 20 Hz inversion frequency with input files and parameters, according to an embodiment.

FIG. 10 illustrates an image of the FWI workspace showing that, once the FWI is executed (e.g., either pilot tests or production), a user can proceed to quality control (QC) the results, according to an embodiment.

FIG. 11 illustrates an image showing that FWI QCs can be performed directly in the 3D data visualization window with the pertinent plotting tools (e.g., axis, color scale, units, different view options, geographic orientation, etc.), according to an embodiment.

FIG. 12 illustrates an image showing that the relevant input and output QC files from FWI are available for display (e.g., total delta velocity, stating model, update model, FWI-derived reflectivity for the updated model, etc.), according to an embodiment.

FIG. 13 illustrates an image of creating a project capturing starting information according to an embodiment.

FIG. 14 illustrates an image of the seismic processing and imaging workspace showing one or more tracks that may be selected, according to an embodiment.

FIG. 15 illustrates an image of the depth imaging track of the seismic processing and imaging workspace, showing one or more tomography workflows for one of the tracks, according to an embodiment.

FIG. 16 illustrates an image of the tomography workspace showing the track including multiple workflows that are organized with a user-centric design into columns based on execution order, according to an embodiment.

FIG. 17 illustrates an image of the tomography workspace showing different workflow steps being linked together with paths, according to an embodiment.

FIG. 18 illustrates an image of the tomography workspace showing a display of the information associated with the workflow and illustrating that a user can proceed to QC the result, according to an embodiment.

FIG. 19 illustrates an image of the tomography workspace showing workflow steps in the paths, according to an embodiment.

FIG. 20 illustrates an image of the tomography workspace showing the additional of additional workflow steps in the paths, according to an embodiment.

FIG. 21 illustrates an image of the tomography workspace showing notifications, according to an embodiment.

FIG. 22 illustrates an image of the tomography workspace showing information about previous model runs and/or builds, according to an embodiment.

FIG. 23 illustrates an image of the tomography workspace showing job details, job execution status, and statistical QC information, according to an embodiment.

FIG. 24 illustrates an image of the tomography workspace showing that, once the tomography inversion is executed, a user can proceed to QC the results, according to an embodiment.

FIGS. 25A and 25B illustrate images (e.g., graphs) showing that tomography QCs can be performed directly in the 3D data visualization window with the pertinent plotting tools, according to an embodiment.

FIG. 26 illustrates an image of the tomography workspace showing notes being stored/viewed through the GUI and the status of export actions, according to an embodiment.

FIG. 27 illustrates an image of the tomography workspace showing the action to promote a select output to a subsequent iteration, according to an embodiment.

FIG. 28 illustrates schematic view of a system for providing standardized seismic processing workflows, according to an embodiment.

FIG. 29 illustrates an image showing information communicated between a cloud computing environment and a workflow execution GUI, according to an embodiment.

FIGS. 30 and 31 illustrate the integration of data-driven data science analysis in the FWI workspace, according to an embodiment.

FIG. 32 illustrates a schematic view of a computing system that is configured to perform at least a portion of the method(s) described herein, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

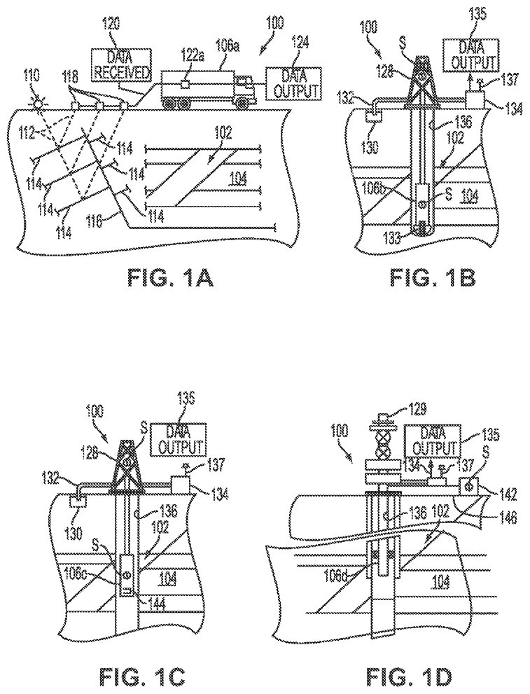

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106a, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122a of a seismic truck 106a, and responsive to the input data, computer 122a generates seismic data output 124. This seismic data output may be stored, transmitted or further processed as desired, for example, by data reduction.

FIG. 1B illustrates a drilling operation being performed by drilling tools 106b suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106b may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106c suspended by rig 128 and into wellbore 136 of FIG. 1B. Wireline tool 106c is adapted for deployment into wellbore 136 for generating well logs, performing downhole tests and/or collecting samples. Wireline tool 106c may be used to provide another method and apparatus for performing a seismic survey operation. Wireline tool 106c may, for example, have an explosive, radioactive, electrical, or acoustic energy source 144 that sends and/or receives electrical signals to surrounding subterranean formations 102 and fluids therein.

Wireline tool 106c may be operatively connected to, for example, geophones 118 and a computer 122a of a seismic truck 106a of FIG. 1A. Wireline tool 106c may also provide data to surface unit 134. Surface unit 134 may collect data generated during the wireline operation and may produce data output 135 that may be stored or transmitted. Wireline tool 106c may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106c to measure downhole parameters which relate to, for example porosity, permeability, fluid composition and/or other parameters of the field operation.

FIG. 1D illustrates a production operation being performed by production tool 106d deployed from a production unit or Christmas tree 129 and into completed wellbore 136 for drawing fluid from the downhole reservoirs into surface facilities 142. The fluid flows from reservoir 104 through perforations in the casing (not shown) and into production tool 106d in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106d or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

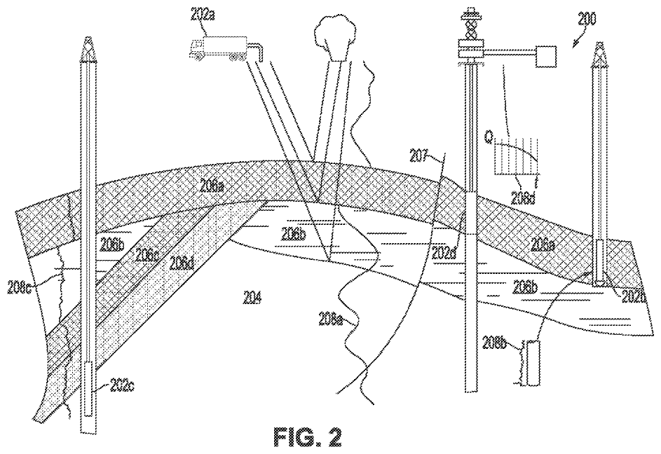

FIG. 2 illustrates a schematic view, partially in cross section of oilfield 200 having data acquisition tools 202a, 202b, 202c and 202d positioned at various locations along oilfield 200 for collecting data of subterranean formation 204 in accordance with implementations of various technologies and techniques described herein. Data acquisition tools 202a-202d may be the same as data acquisition tools 106a-106d of FIGS. 1A-1D, respectively, or others not depicted. As shown, data acquisition tools 202a-202d generate data plots or measurements 208a-208d, respectively. These data plots are depicted along oilfield 200 to demonstrate the data generated by the various operations.

Data plots 208a-208c are examples of static data plots that may be generated by data acquisition tools 202a-202c, respectively; however, it should be understood that data plots 208a-208c may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208a is a seismic two-way response over a period of time. Static plot 208b is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208c is a logging trace that typically provides a resistivity or other measurement of the formation at various depths.

A production decline curve or graph 208d is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206a-206d. As shown, this structure has several formations or layers, including a shale layer 206a, a carbonate layer 206b, a shale layer 206c and a sand layer 206d. A fault 207 extends through the shale layer 206a and the carbonate layer 206b. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208a from data acquisition tool 202a is used by a geophysicist to determine characteristics of the subterranean formations and features. The core data shown in static plot 208b and/or log data from well log 208c are typically used by a geologist to determine various characteristics of the subterranean formation. The production data from graph 208d is typically used by the reservoir engineer to determine fluid flow reservoir characteristics. The data analyzed by the geologist, geophysicist and the reservoir engineer may be analyzed using modeling techniques.

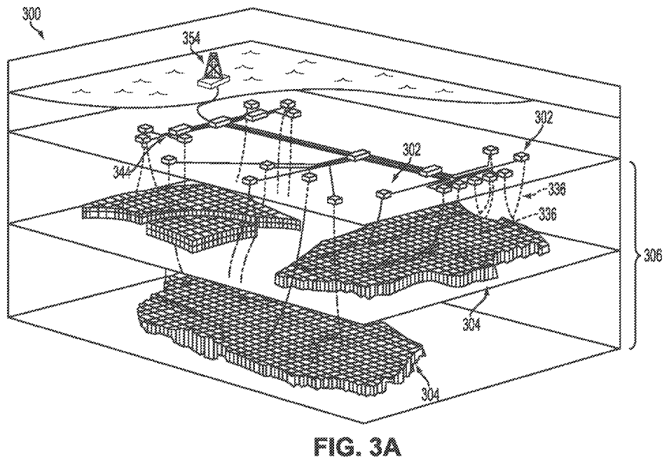

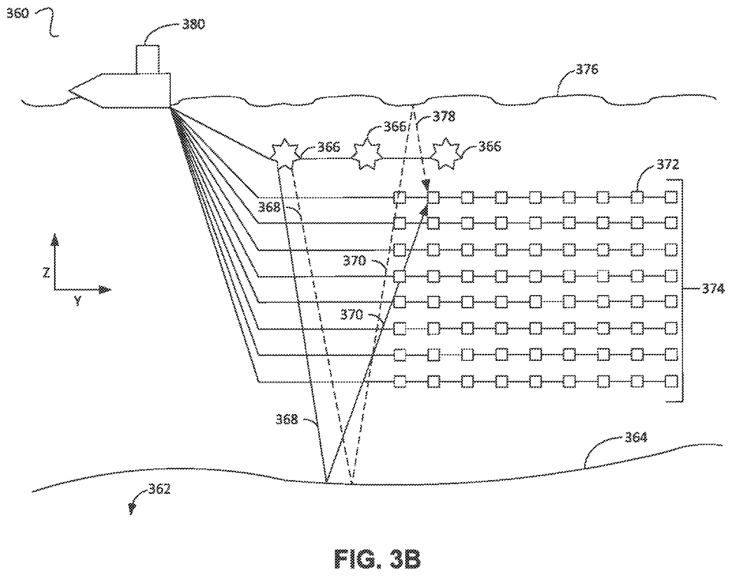

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the Earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

### A System and Method for Providing and Executing Seismic Processing Workflows

Embodiments of the present disclosure provide a “bespoke” execution and quality control (QC) process for a workflow that may be used in seismic data processing. A user-centric design aims to accelerate the execution of the workflow for users of varying abilities, through the concepts of standardization, simplification, bespoke QC, data lineage tracking, smart data management, cloud-native-ness, high-performance compute, scalability, rating, or a combination thereof. In contrast, conventional processing systems put the burden on the end-user to construct the piece of the workflow that is used to create a result, to manage compute and data requirements of the workflow, to manage input and output datasets, to set up the relevant QCs for the workflow, and to ensure the size of the data can fit in the system they are using.

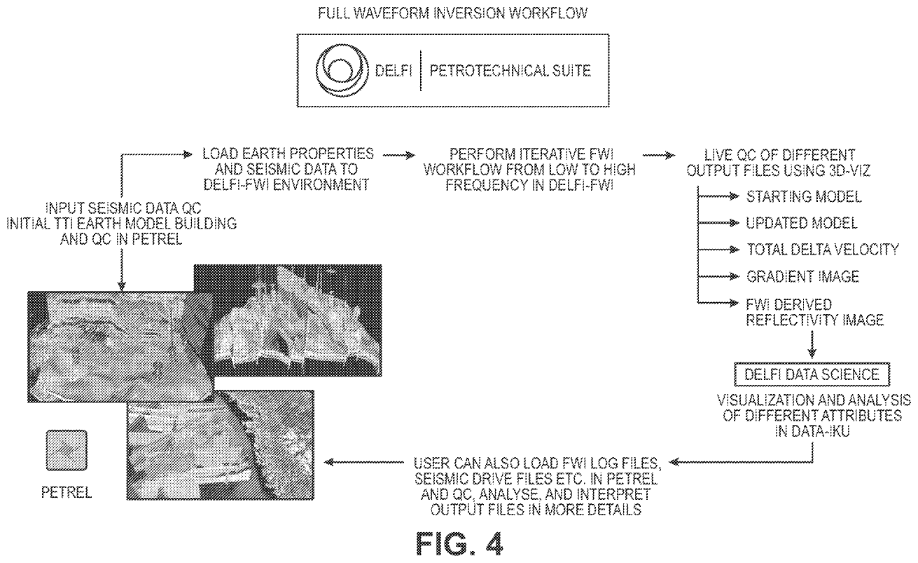

FIG. 4 illustrates a flowchart of a method for full waveform inversion (FWI) of seismic data, according to an embodiment. The flowchart may be used to produce seismic images, models, attributes, etc., in an effort to infer information about the subsurface domain. The method may be iterative (e.g., a loop) as shown. Beginning on the left side of FIG. 4, the method, in some embodiments, may begin by inputting seismic data, an initial tilted transverse isotropy (TTI) earth model, and seismic quality control (QC) data into an exploration and production (E&P) software platform, such as PETREL®. The earth properties may then be loaded into a module of the E&P platform, or a different platform (e.g., DELFI®), which may provide the underlying data for performing the inversion. The method may then include performing an iterative FWI workflow from low to high frequency (e.g., using the platform), which may be employed to generate a new and/or updated model of one or more properties of the subsurface. A live QC of different output files may then be conducted (e.g., for the starting model, updated model, total delta velocity, gradient image, and/or FWI-derived reflectivity image).

Next, the method may provide visualization and analysis of different attributes of the quality-checked models, images, and/or other properties. A user can also upload FWI log files, seismic drive files, etc., in the platform and perform QC, analysis, and interpret output files in more detail. This output may then be used for subsequent rounds of inversion (e.g., based on subsequent seismic datasets input), as at the beginning of the loop just described.

Thus, the system and method may include a dynamic graphic user interface of a seismic workflow execution workspace. The dynamic nature of embodiments of the graphic user interface of the workspace enables access to multiple user interfaces of one or more processes of a complex workflow integrated into a single interface. Moreover, the dynamic graphic user interface enables modification of the one or more processes and the workflow without accessing multiple standalone user interfaces separately for each process of workflow. In addition, the graphic user interface enables access to the status of the process and access to data, graphs, results, visualizations, and other information about one or more aspect of one or more instances of the workflow. The dynamic graphic user interface as described herein enables a visualization of how processes and data are linked to create the workflow. Embodiments also enable a user to modify the process through the dynamic graphic user interface, without accessing a separate process interface. Other benefits are described and illustrated through the description of embodiments herein.

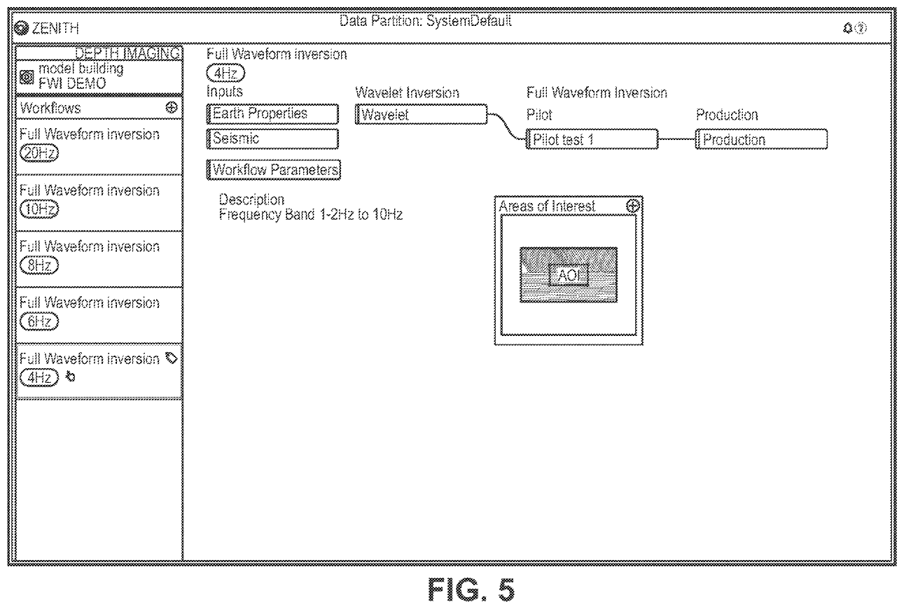

FIG. 5 illustrates an embodiment of a dynamic graphic user interface of a workspace showing tabs related to input to the FWI workflow (e.g., earth properties, seismic data, and workflow parameters) along with two FWI steps: wavelet inversion and full-waveform inversion. The different frequencies are shown in the left column from low to high (e.g., 4 Hz to 20 Hz) for multi-stage FWI execution. This display shows the full seismic shot location map from multiple surveys along with an area of interest (AOI). The data from the AOI may be used for pilot testing and surveying for production.

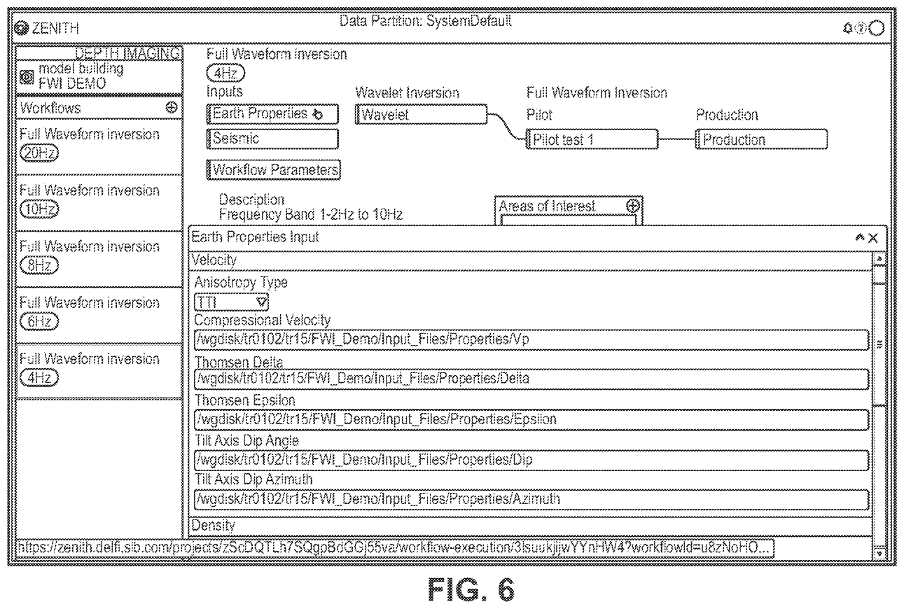

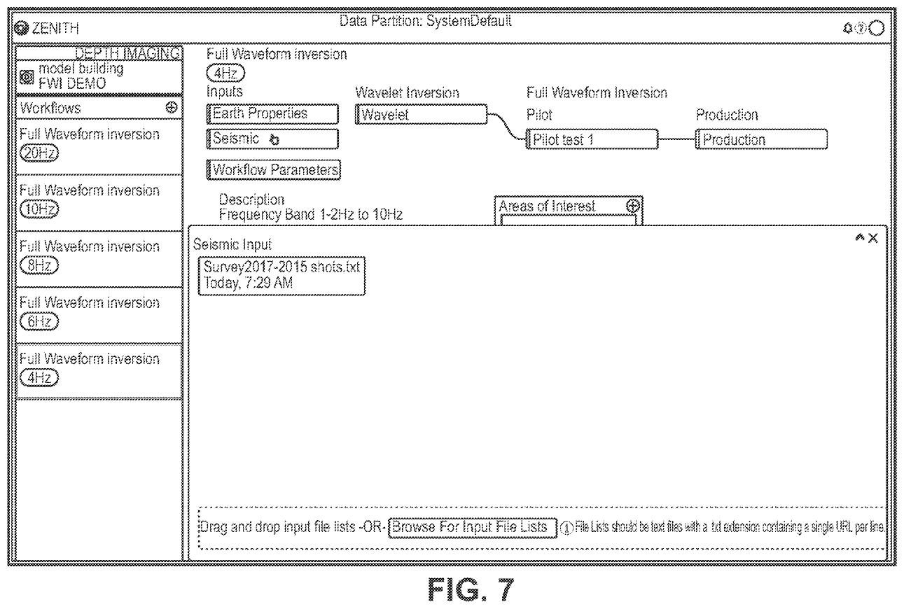

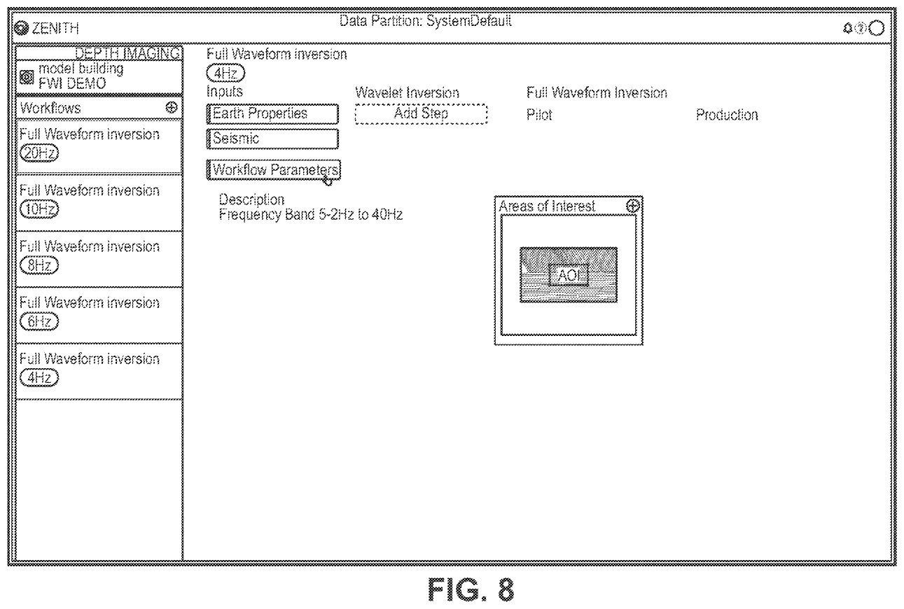

The tabs may be dynamic and link to other information within the graphical user interface. For example, referring to FIG. 6, there is shown the graphical user interface (GUI) depicting a list of earth properties, which is displayed in response to a user input selecting the “Earth Properties” tab. Specifically, this list illustrates TTI model property files (e.g., Vp, Delta, Epsilon, Dip, and Azimuth). It will be appreciated that other data may be displayed in a similar list, depending on the user selection of the different tabs. Similarly, other types of data may be displayed in response to other tabs being selected. For example, clicking on the “Seismic” tab may show a text file containing the location paths of input seismic sail-lines from multiple surveys, as shown in FIG. 7. Different frequencies may be selected by clicking on the desired frequency in the left column, as shown in FIG. 8.

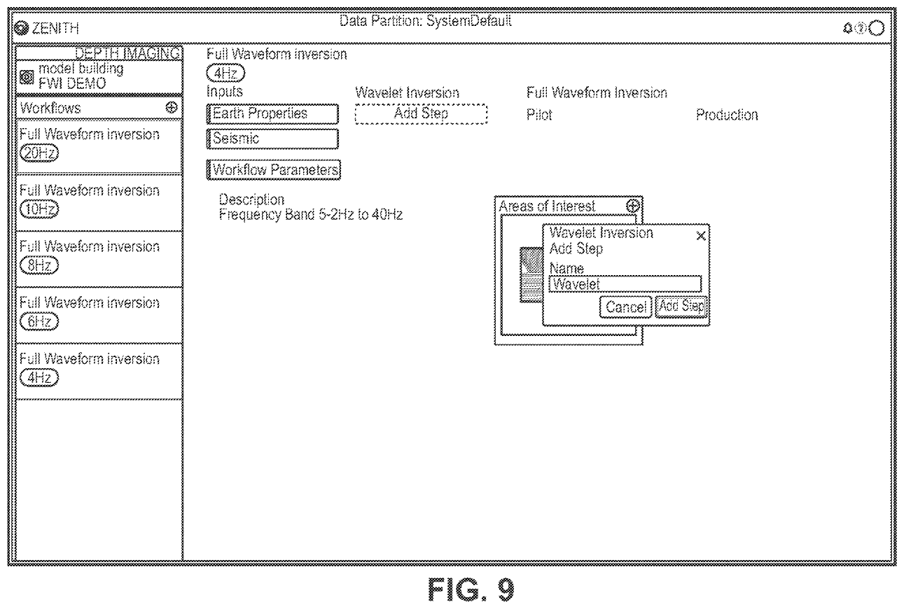

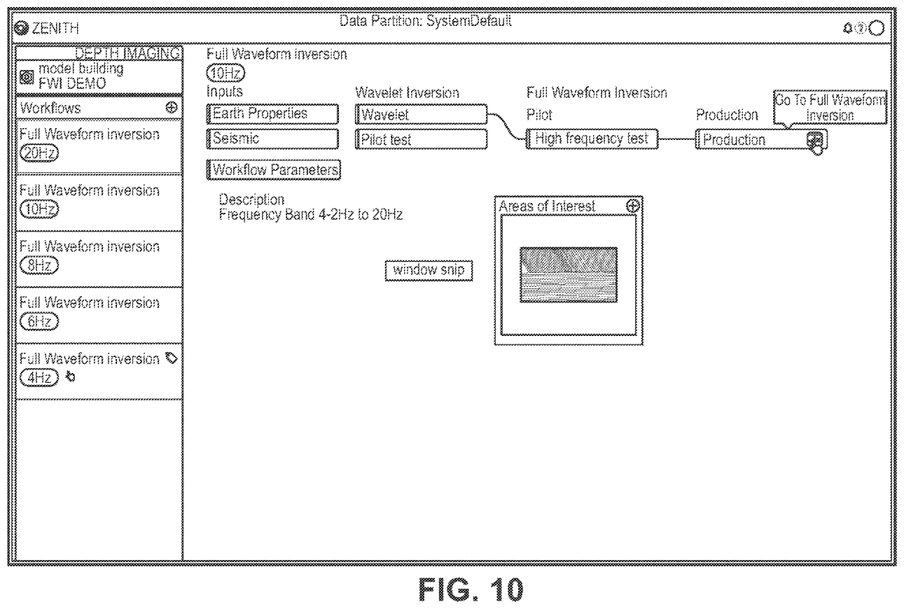

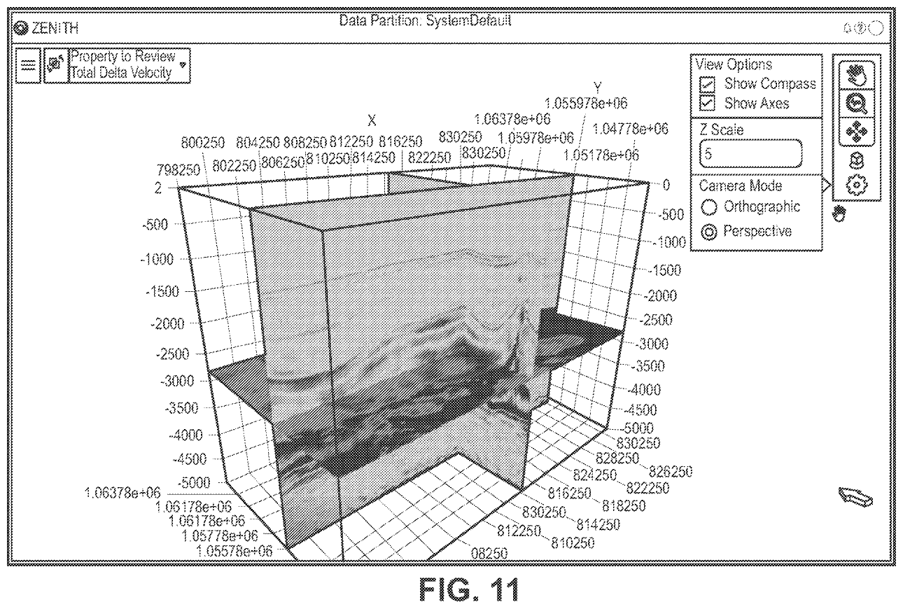

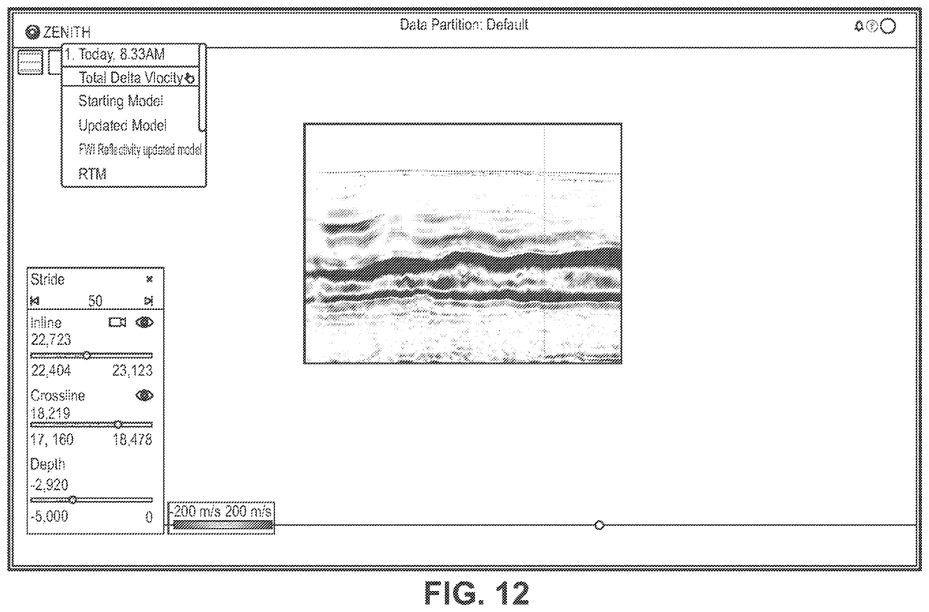

The graphical user interface may also permit dynamic modification of the FWI (or other, e.g., tomographic) workflows. For example, as shown in FIG. 9, steps can be added (e.g., wavelet inversion for 20Hz inversion frequency with input files and parameters mentioned earlier). The “step” added is identified as “wavelet” in the highlighted pop-up box. As the step is added, a parameterization interface may be provided for accepting user-input for the step (e.g., parameters that may be called for to perform the step, including an output name). This parameterization interface will have been specifically configured for the step as part of the standardized workflow template. As shown in FIG. 10, once the FWI process/steps are established, and the FWI is executed, the GUI may provide for QC review of the results, with the QC tailored to the specifications of the specific workflow as part of the QC template, which has been referenced by the standardized workflow template in which the step has been defined. An example of such results, in three-dimensions, is shown in FIG. 11. QC workflows can be performed directly in the 3D visualization window with available plotting tools such as axis, color, scale, units, different view options, graphical orientation, etc. The relevant input and output files from the FWI may be available for display (e.g., total delta velocity, starting model, updated model, FWI-derived reflectivity for the updated model, etc.), as shown, for example, in FIG. 12. A variety of other outputs, metrics, graphs, plots, displays, etc., which may be generated by the FWI, can also be accessed via inputs to the GUI in similar fashion.

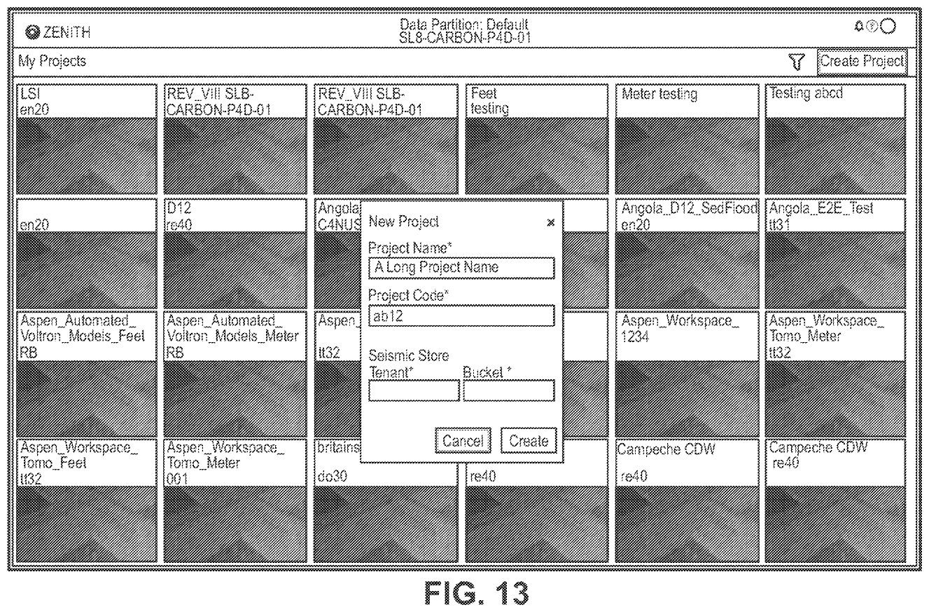

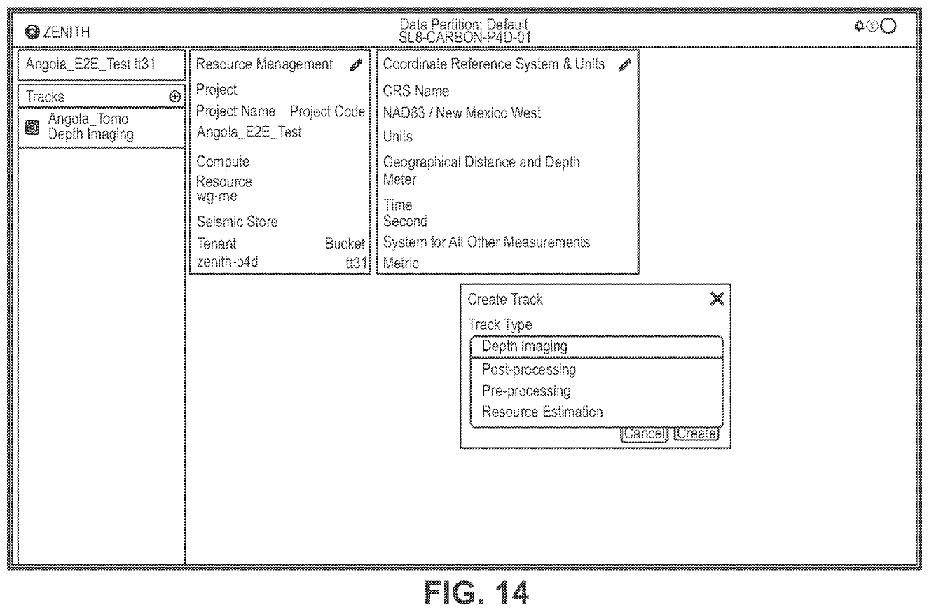

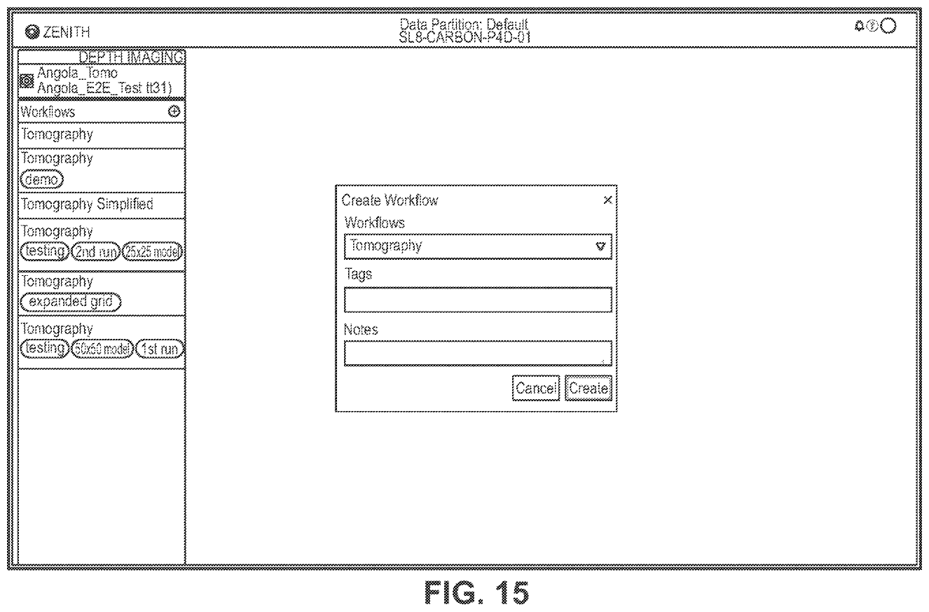

The foregoing has outlined one possible use-case for the GUI. The following provides a discussion of a creation of a project. The creation of the project may begin, as shown in FIG. 13, with a pop-up, which provides for relevant starting information, such as project name, codes, templates, etc. The platform that executes the workflows within the projects may provide templates and other baseline information that may be selected at this stage. As shown in FIG. 14, the definition of project attributes can be made (e.g., Coordinate Reference System & Units) with these project attributes characterizing the availability of tracks, workflows, workflow steps, and the pre-population of workflow parameters. As shown in FIG. 14, one or more tracks, which may link together workflows (e.g., from an available template), can be created for the project. As shown in FIG. 15, one or more workflows for the track can be created.

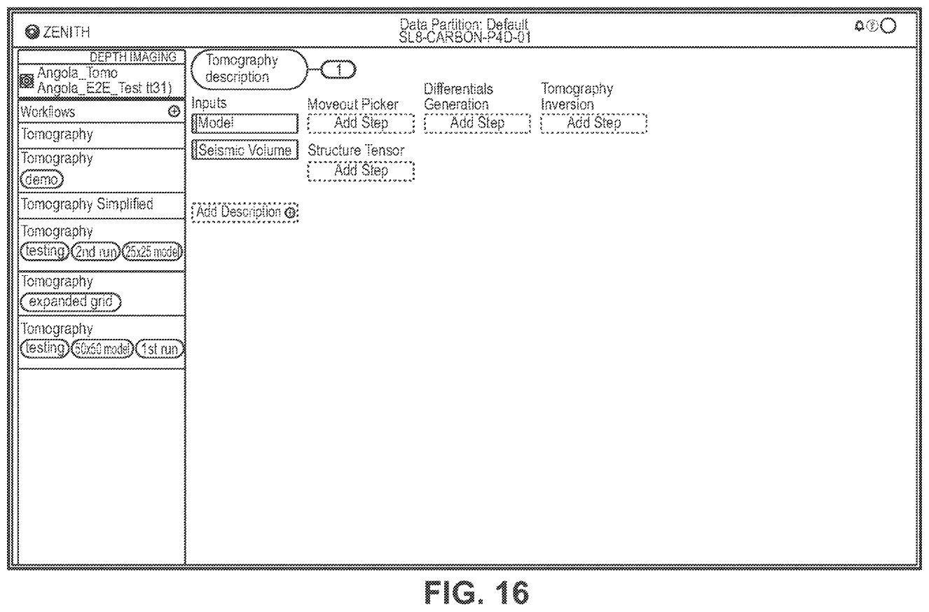

Each track may show multiple workflows as selectable entities (e.g., as “tabs”) organized into columns based on execution order, for example, as shown in FIG. 16, or based on another order defined by the system or by the users. In this case, a depth imaging track (e.g., linked workflows) is provided. Each entity in the depth imaging track may represent a different workflow, information output, or any other component of the track. The track, in turn, may lead to a process output, which may feed into subsequent tracks or may represent an output for the project. Various model templates, process templates, etc. may be accessible to perform the individual workflows.

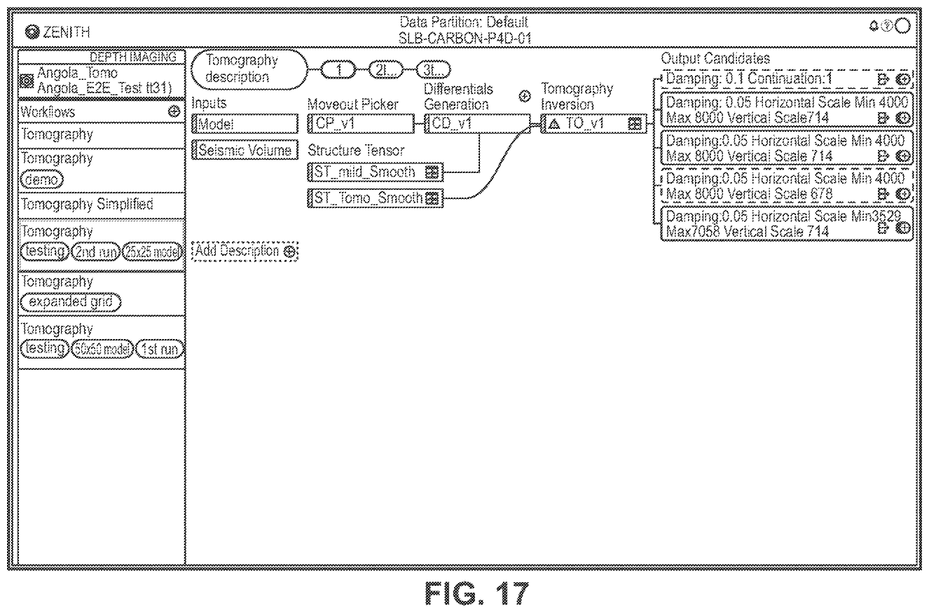

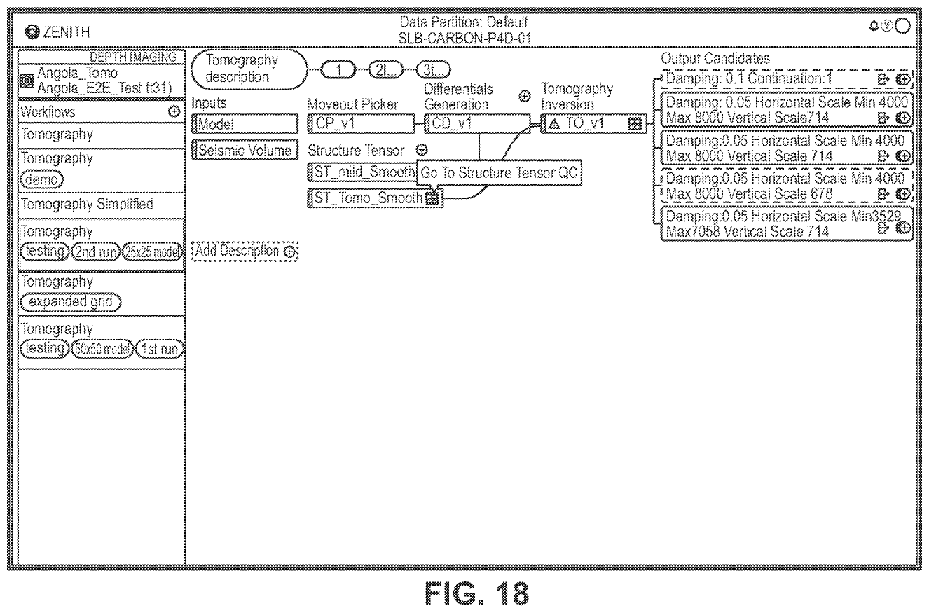

As shown in FIG. 17, the different workflows can be linked together with paths, which may define an execution order and/or dependency in the tracks and among the workflows and/or flow of datasets. The paths may be unidirectional, or may be bi-directional or otherwise, such that changing/rerunning one workflow may automatically cause another workflow to re-execute with the appropriately updated data, or may simply illustrate that execution of one may impact the output of another. Each of the tabs representing the workflows may be linked to information dynamically. For example, hovering a mouse cursor, or any other user input, may provide a display of what is associated with the workflow, as shown in FIG. 18.

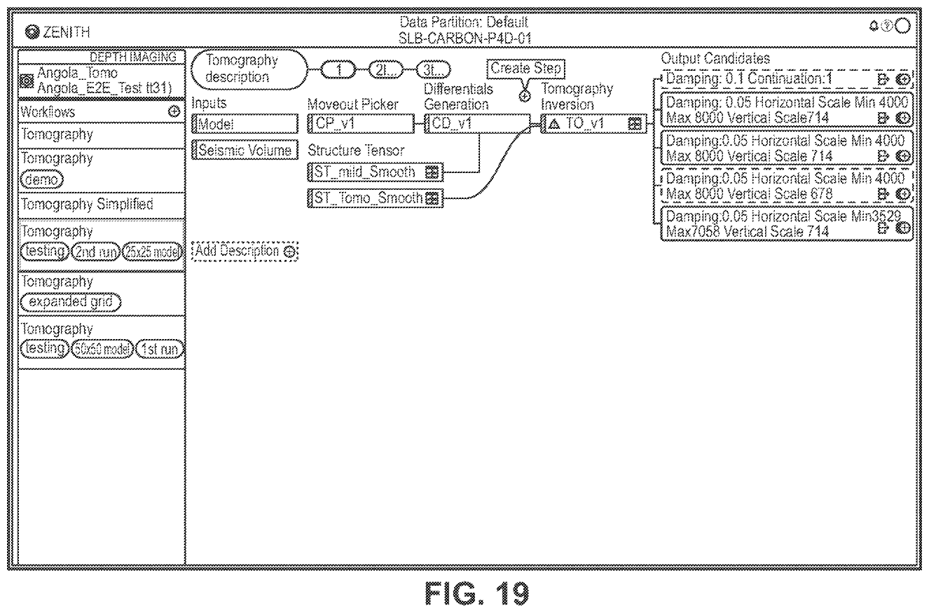

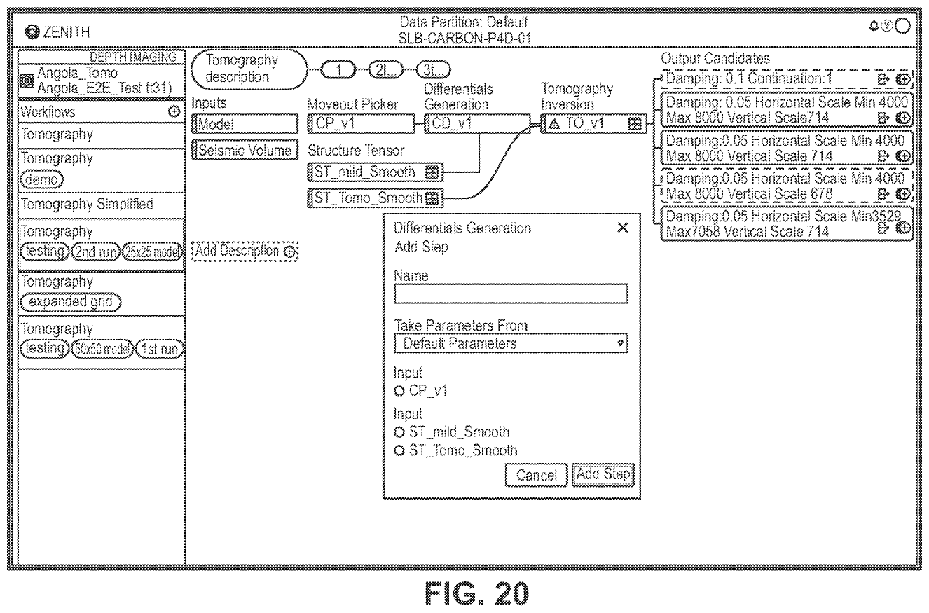

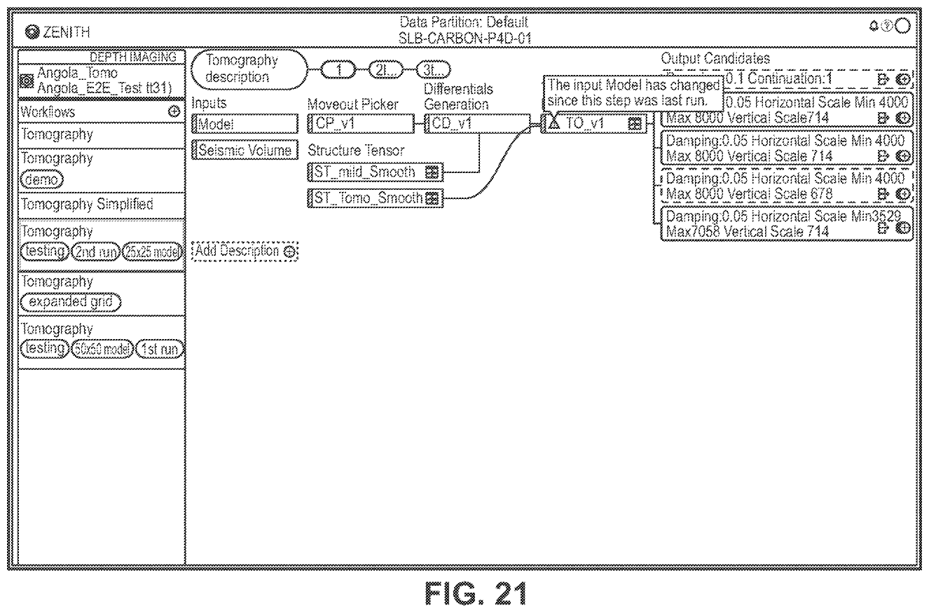

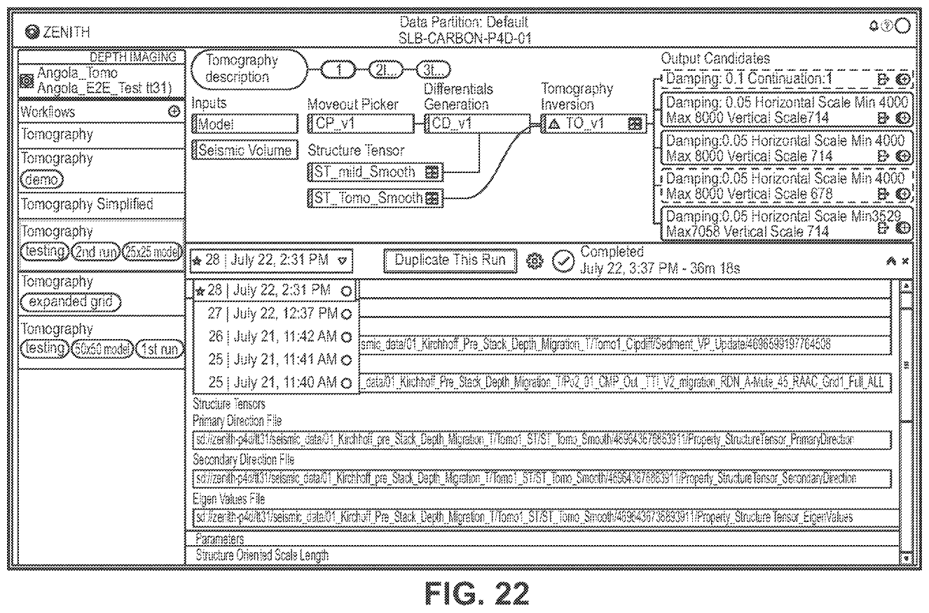

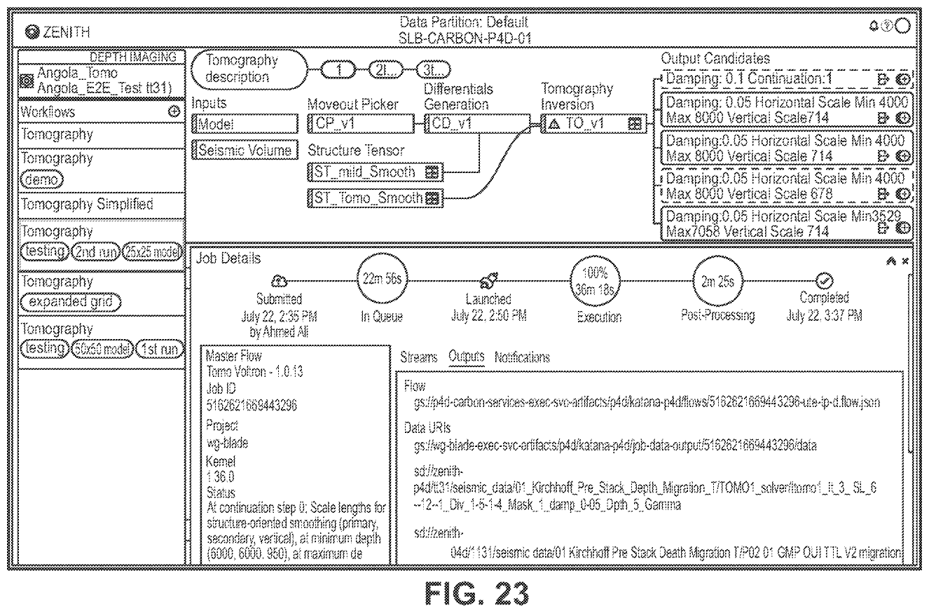

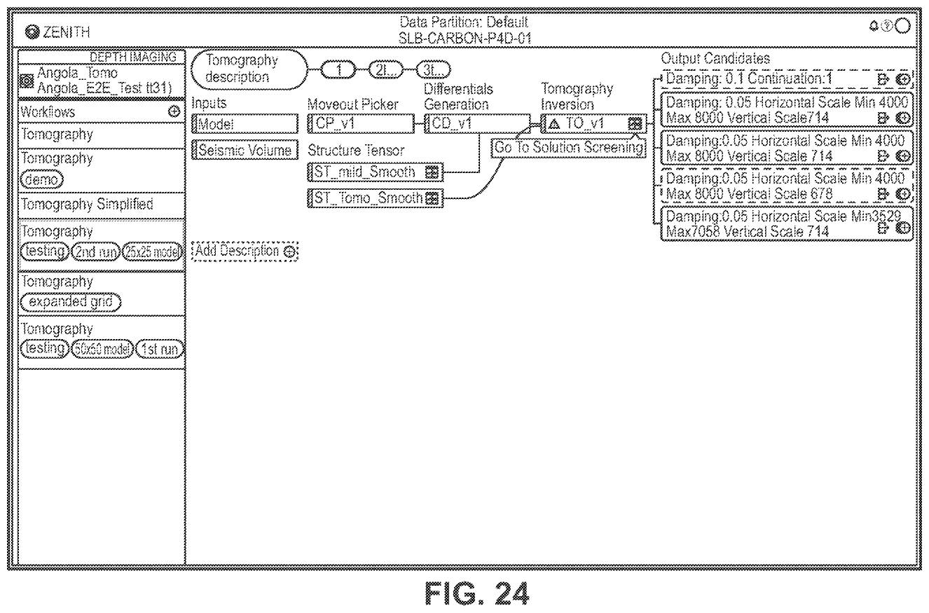

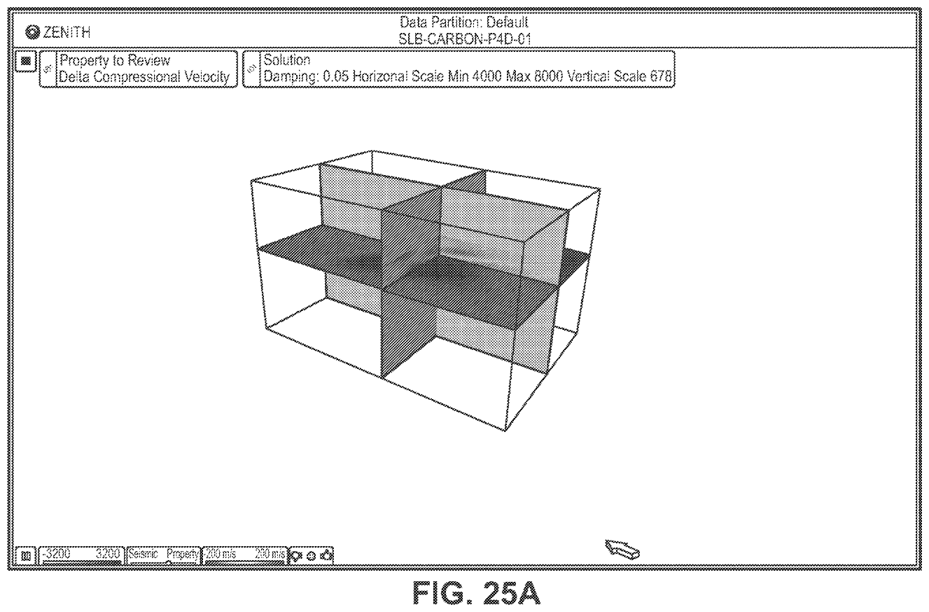

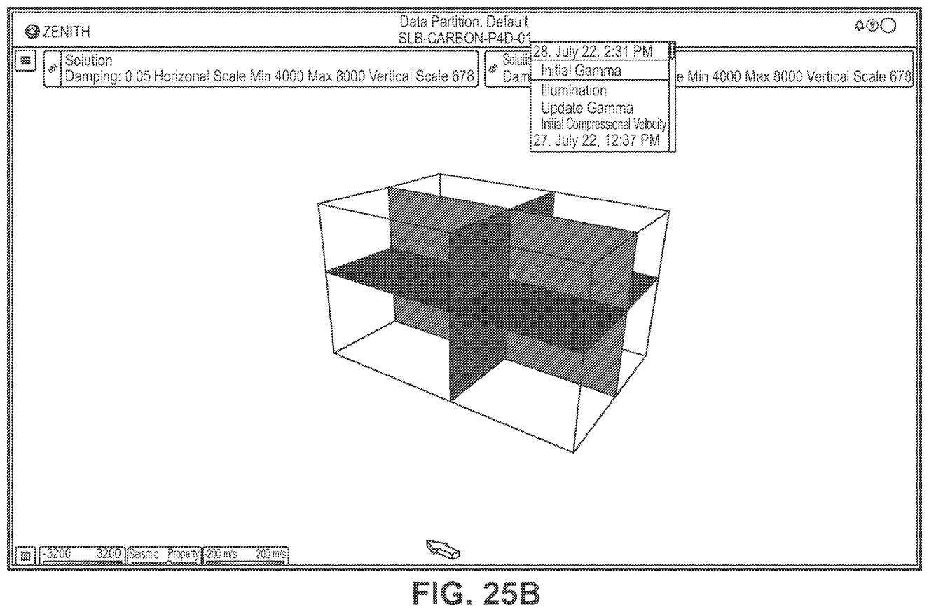

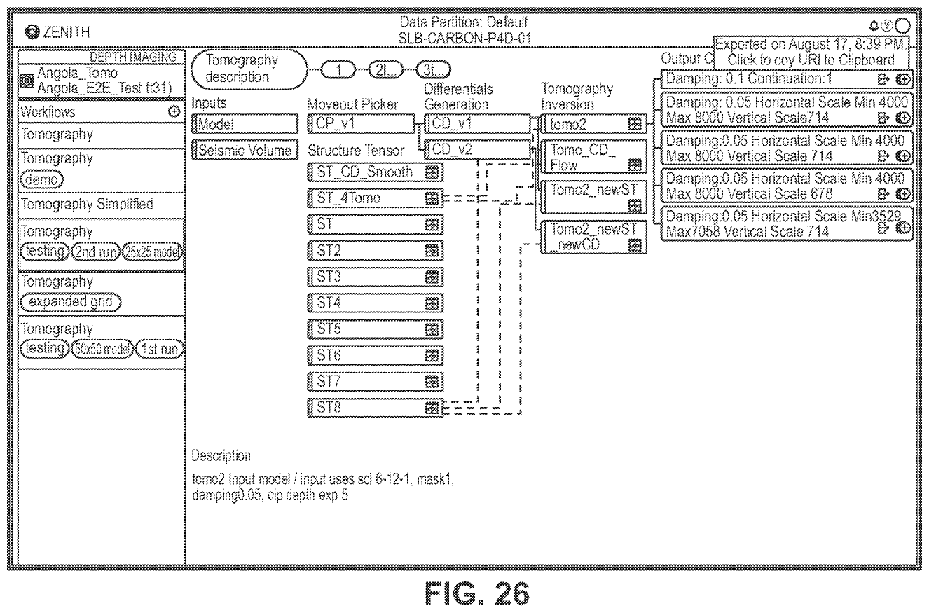

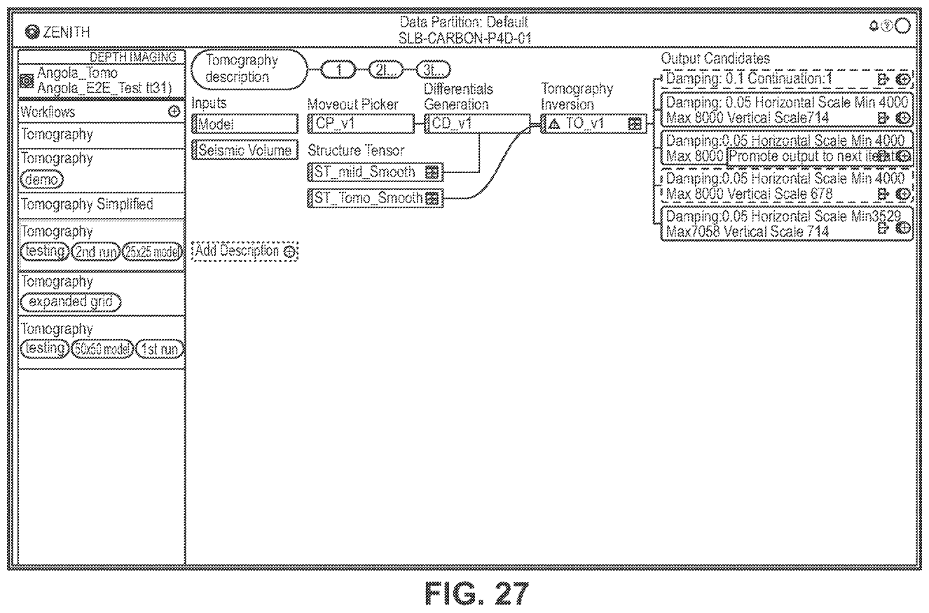

In some embodiments, “steps” in the paths can be created, as shown in FIGS. 19 and 20. The GUI can also provide notifications as to whether a given model/workflow should be re-run/updated, as shown in FIG. 21. Clicking or otherwise selecting the tab may provide information about previous model runs/builds, preferred model runs/builds (e.g., indicated by a star), status of previous model runs/builds (indicated by traffic light signal) etc., as shown in FIG. 22, as well as job details, as shown in FIG. 23. The farthest right column in FIG. 24 may present outputs of the different workflow steps. These output tabs may be selected to permit viewing/QC of the outputs, as shown in FIGS. 25A and 25B, or to present actions to the user (e.g., choosing a specific output to move to the next iteration). Notes or other data related to paths can also be stored/viewed through the GUI, as shown in FIG. 26. Once an output is reviewed and run through QC, it can be promoted to a next workflow, as shown in FIG. 27.

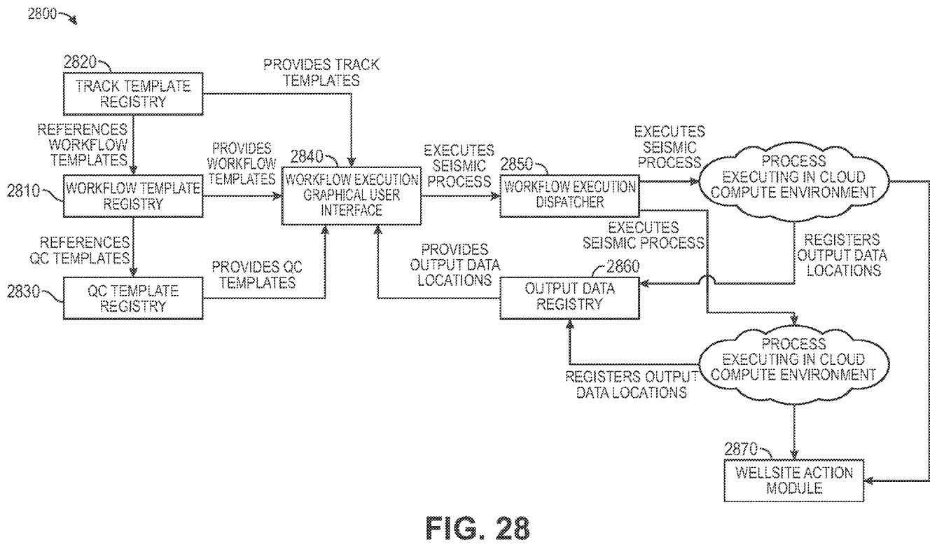

FIG. 28 illustrates a schematic view of a system 2800 for providing standardized seismic processing workflows, according to an embodiment. The system 2800 may be part of (or run on) the computing system 3200 described below. As used herein, “standardized” refers to consistently defined, generated, and applied processes that are aligned across users and ensure needs are met.

The system 2800 may include a workflow template registry 2810. The workflow template registry 2810 may be configured to register a plurality of workflow templates that each include one or more steps. As used herein, a “workflow template” refers to a document that configures features of the workflow execution graphical user interface 2840 to present a standardized workflow to end-users. Configuration may include workflow inputs (as shown in FIG. 6 and FIG. 7); standardized workflow steps (as shown in FIG. 9) including parameter interfaces (FIG. 22) for those steps and GUI capabilities utilized by those steps (such as Areas of Interest); references to a QC template that would enable output QC for a step (FIG. 10), and relations between all of the aforementioned components. The one or more steps may include a seismic processing step that produces output seismic data. The workflow templates may include defined antecedent or subsequent workflow templates. The workflow templates may be or include tomography (see FIG. 16), full waveform inversion (FWI—See FIG. 5), both, or other workflows (e.g. Noise Attenuation, Multiple Attenuation, Model Merging, Interpretation).

The workflow template registry 2810 may also be configured to register a plurality of parameters that are related to the workflow templates. The parameters may include input data locations, output data locations, geophysical algorithm parameters, or a combination thereof. As used herein, a “data location” refers to a unique identification of a dataset through either a defined location in a storage system or through a unique identifying name or attribute.

The workflow template registry 2810 may also be configured to register a plurality of workflow template conditions that are related to the workflow templates. The workflow template conditions may include a geological setting (e.g., Gulf of Mexico deep-water salt basin), a seismic processing project objective (e.g., sub-salt imaging), a seismic processing project data type (e.g., ocean bottom node (OBN)), a seismic processing project work scope (e.g., FWI, tomography, least-squares migration, post-migration processing), or a combination thereof. The seismic processing project may include a customer name, a project name, an accounting code, the geological setting, the seismic processing project objective, the seismic processing project data type, the seismic processing project work scope, or a combination thereof.

The system 2800 may also include a workflow execution track template registry 2820. The workflow execution track template registry 2820 may be configured to register a plurality of track templates. As used herein, a “track template” refers to a pre-configuration of the GUI that would be seen by end-users, defined by the workflows to be made available under the track and their relation to one another. Each track template may include one or more of the workflow templates. The workflow execution track template registry 2820 may also be configured to register a plurality of track template conditions that are related to the track templates. The track template conditions may include one or more of the workflow template conditions (e.g., the geological setting, the seismic processing project objective, the seismic processing project data type, and/or the seismic processing project work scope).

The system 2800 may also include a quality control (QC) template registry 2830. The QC template registry 2830 may be configured to register a plurality of QC templates that configure a seismic processing data visualization environment. As used herein, a “QC template” refers to a pre-configuration of the data visualization displays that would be seen by end-users, defined by the input and output datasets, the methods through which the datasets will be visually examined, and the locations of the displays and their interactions with each other. The QC templates may be associated with the one or more steps in the workflow templates, which provides an ability to display and review the output seismic data and diagnostic data of the seismic processing step in a standardized manner.

The system 2800 may also include a workflow execution graphical user interface (GUI) 2840. The workflow execution graphical user interface 2840 may be configured to enable a definition of a seismic processing project. An example of the seismic processing project may be seen in FIG. 13. The seismic processing project may include a plurality of tracks and/or a sequence of seismic processing activities to achieve an end objective. The tracks may be created based upon the track templates and/or the track template conditions. An example of this may be seen in FIG. 14. Each track may provide a selection of the workflow templates that have been registered with the workflow template registry and/or created in a context of the respective track. An example of this may be seen in FIG. 15. In an embodiment, only the workflow templates in which the track template conditions are met are provided in the selection. The QC templates may configure the workflow execution graphical user interface to present one or more data visualization interfaces. The workflow execution graphical user interface supports viewing the output seismic data in one or more data visualization interfaces. An example of this may be seen in FIG. 25. The one or more data visualization interfaces may display 2D seismic data and model data and 3D seismic data and model, well data, geological data, charts and graphs of data related to a performance or a quality of the seismic processing step, geographical maps displaying data associated with the seismic processing step, or a combination thereof. An example of the 2D and/or 3D seismic data and model may be seen in FIG. 25. The workflow execution graphical user interface may provide recommendations on the parameters based on displays configured in the QC templates. The output seismic data from a first step of the one or more steps (or the parameters from the first step in one or more of the workflow templates) may be configured to be automatically configured as the parameters for a subsequent step of the one or more steps in the same workflow template, as defined by the workflow templates. An example of this may be seen in FIG. 27.

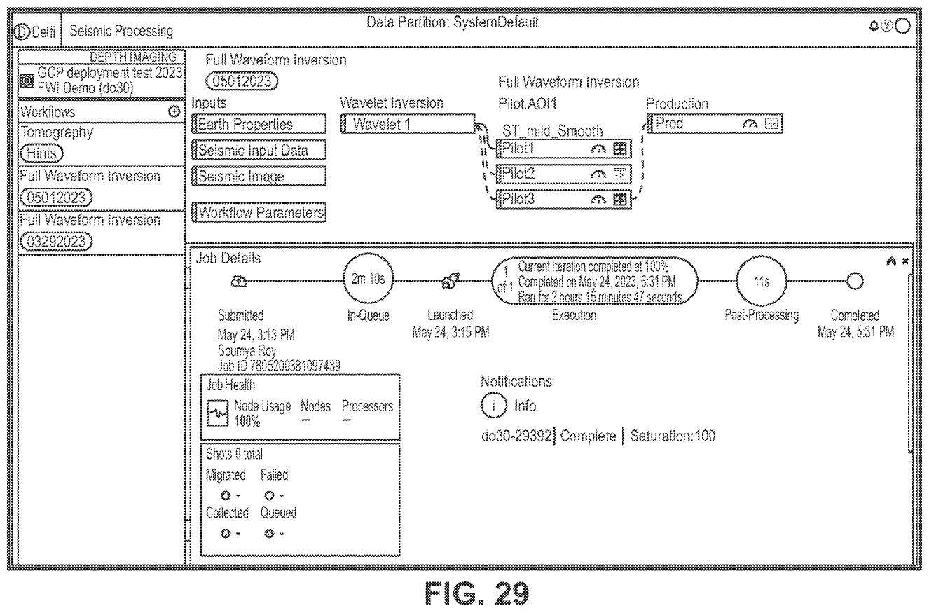

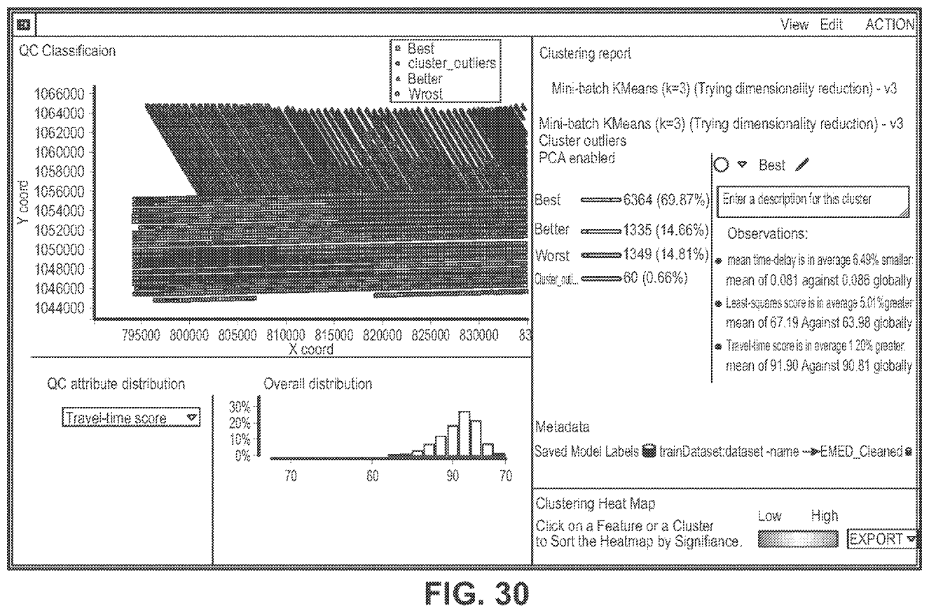

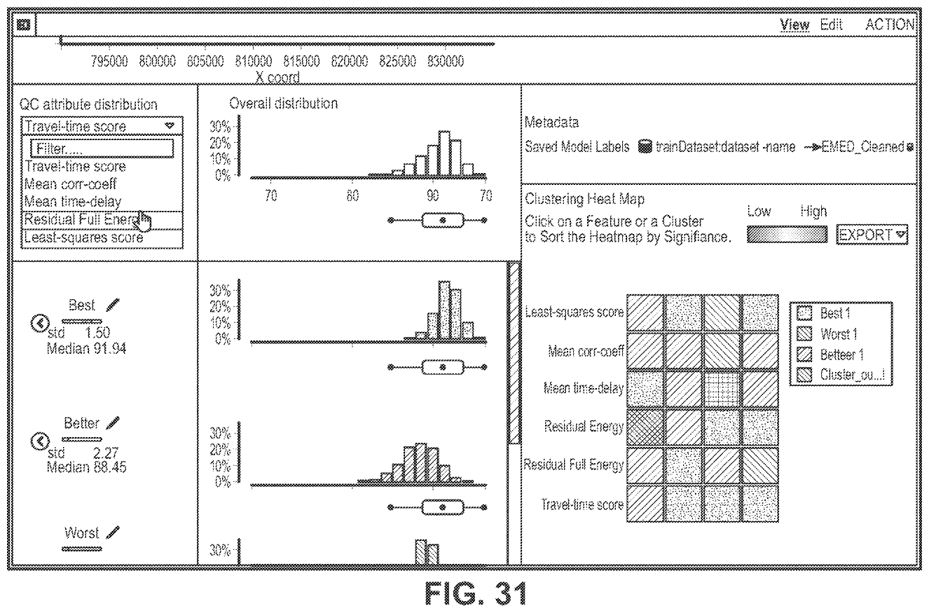

The system 2800 may also include a workflow execution dispatcher 2850. The workflow execution dispatcher 2850 may be configured to cause one or more of the steps to interact with one or more cloud computing environments. One or more interfaces and/or protocols may facilitate data to be communicated between the one or more cloud computing environments and/or the workflow execution graphical user interface. The data communicated between the cloud computing environment and the workflow execution graphical user interface may include error or success conditions of an execution of one or more of the steps of the workflow templates, locations of the output seismic data, diagnostic information on a computational efficiency, diagnostic information on computational failures, a cost of the workflow step, a convergence metric, or a combination thereof. Examples of this may be seen in FIGS. 29-31. A successful execution of a first workflow step in one or more of the workflow templates may automatically trigger an execution of a second workflow step in the one or more of the workflow templates. As used herein, a “successful execution” means that the step or workflow was performed and produced an output without causing an error. An example of a “workflow step” may include picking the residual moveout on migrated gathers. The successful execution of a first of the one or more workflow templates within one or more of the track templates may automatically trigger an execution of a second of the one or more workflow templates within one or more of the track templates.

The system 2800 may also include an output data registry 2860. Computational processes that are configured by the workflow steps to execute in locations on the one or more cloud computing environments may communicate the output seismic data by registering the locations in the output data registry 2860. Standardized identifiers may be used to correlate the output seismic data to the parameters or the input data locations used in the seismic processing data visualization environment via configuration in one or more of the QC templates, or for use in subsequent workflow steps configured in one or more of the workflow templates.

The system 2800 may also include a wellsite action module 2870. The wellsite action module 2870 may be configured to generate or transmit a signal that causes a wellsite action to take place at a wellsite in response to the output seismic data. The wellsite action may be performed based upon the output seismic data. The wellsite action may be or include generating and/or transmitting a signal (e.g., using a computing system) that causes a physical action to occur at a wellsite. The wellsite action may also or instead include performing the physical action at the wellsite. The physical action may be or include varying a weight and/or torque on a drill bit, varying a drilling trajectory, varying a concentration and/or flow rate of a fluid pumped into a wellbore, or the like.

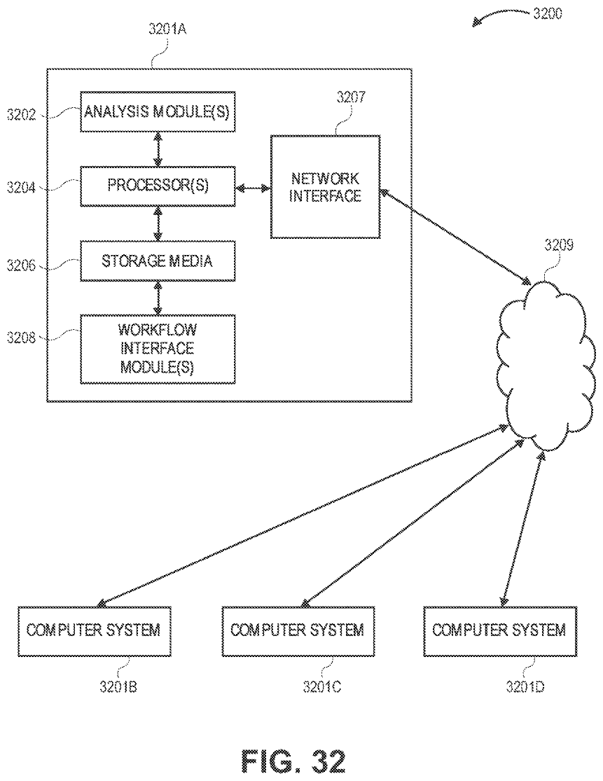

In some embodiments, any of the methods of the present disclosure may be executed using a system, such as a computing system. FIG. 32 illustrates an example of such a computing system 3200, in accordance with some embodiments. The computing system 3200 may include a computer or computer system 3201a, which may be an individual computer system 3201a or an arrangement of distributed computer systems. The computer system 3201a includes one or more analysis module(s) 3202 configured to perform various tasks according to some embodiments, such as one or more methods disclosed herein. To perform these various tasks, the analysis module 3202 executes independently, or in coordination with, one or more processors 3204, which is (or are) connected to one or more storage media 3206. The processor(s) 3204 is (or are) also connected to a network interface 3207 to allow the computer system 3201a to communicate over a data network 3209 with one or more additional computer systems and/or computing systems, such as 3201b, 3201c, and/or 3201d (note that computer systems 3201b, 3201c and/or 3201d may or may not share the same architecture as computer system 3201a, and may be located in different physical locations, e.g., computer systems 3201a and 3201b may be located in a processing facility, while in communication with one or more computer systems such as 3201c and/or 3201d that are located in one or more data centers, and/or located in varying countries on different continents).

A processor can include a microprocessor, microcontroller, processor module or subsystem, programmable integrated circuit, programmable gate array, or another control or computing device.

The storage media 3206 can be implemented as one or more computer-readable or machine-readable storage media. Note that while in the example embodiment of FIG. 32 storage media 3206 is depicted as within computer system 3201a, in some embodiments, storage media 3206 may be distributed within and/or across multiple internal and/or external enclosures of computing system 3201a and/or additional computing systems. Storage media 3206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 3200 contains one or more workflow interface module(s) 3208. In the example of computing system 3200, computer system 3201a includes the workflow interface module 3208. In some embodiments, a single workflow interface module 3208 may be used to perform some or all aspects of one or more embodiments of the methods. In alternate embodiments, a plurality of workflow interface modules 3208 may be used to perform some or all aspects of methods.

It should be appreciated that computing system 3200 is only one example of a computing system, and that computing system 3200 may have more or fewer components than shown, may combine additional components not depicted in the example embodiment of FIG. 32, and/or computing system 3200 may have a different configuration or arrangement of the components depicted in FIG. 32. The various components shown in FIG. 32 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 3200, FIG. 32), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computing system for providing standardized seismic processing workflows, the system comprising:
a workflow template registry configured to register a plurality of workflow templates that each include one or more steps that produce output seismic data;
a workflow execution track template registry configured to register a plurality of track templates, each track template includes one or more of the workflow templates;
a workflow execution graphical user interface configured to enable a definition of a seismic processing project, the seismic processing project includes a plurality of tracks and a sequence of seismic processing activities;
a workflow execution dispatcher configured to cause the one or more steps to interact with a cloud computing environment; and
an output data registry, computational processes that are configured by the one or more steps to execute in locations on the cloud computing environment communicate the output seismic data by registering the locations in the output data registry.

2. The computing system of claim 1, wherein the one or more steps include a seismic processing step that produces the output seismic data, and the workflow templates include tomography, full waveform inversion (FWI), or both.

3. The computing system of claim 1, wherein the workflow template registry is also configured to register a plurality of parameters that are related to the workflow templates, and the parameters include input data locations, output data locations, geophysical algorithm parameters, or a combination thereof.

4. The computing system of claim 1, wherein the workflow template registry is also configured to register a plurality of workflow template conditions that are related to the workflow templates, and the workflow template conditions include a geological setting, a seismic processing project objective, a seismic processing project data type, a seismic processing project work scope, or a combination thereof.

5. The computing system of claim 4, wherein the track template conditions include one or more of the workflow template conditions.

6. The computing system of claim 1, comprising a quality control (QC) template registry configured to register a plurality of QC templates that configure a seismic processing data visualization environment, the QC templates are associated with the one or more steps in the workflow templates, which provides an ability to display and review the output seismic data in a standardized manner.

7. The computing system of claim 1, wherein the workflow execution track template registry is also configured to register a plurality of track template conditions that are related to the track templates, the tracks are created based upon the track templates and the track template conditions, and each track provides a selection of the workflow templates that have been registered with the workflow template registry.

8. The computing system of claim 7, wherein only the workflow templates in which the track template conditions are met are provided in the selection, and the workflow execution graphical user interface provides recommendations on the parameters based on displays configured in the QC templates.

9. The computing system of claim 1, wherein a successful execution of a first workflow step in one or more of the workflow templates automatically triggers an execution of a second workflow step in the one or more of the workflow templates, and the successful execution of a first of the one or more workflow templates within one or more of the track templates automatically triggers an execution of a second of the one or more workflow templates within one or more of the track templates.

10. The computing system of claim 1, comprising a wellsite action module that causes a wellsite action to take place at a wellsite in response to the output seismic data.

11. A computing system for providing standardized seismic processing workflows, comprising:
a workflow template registry configured to register:
a plurality of workflow templates that each include one or more steps, the one or more steps include a seismic processing step that produces output seismic data, and the workflow templates include tomography, full waveform inversion (FWI), or both;
a plurality of parameters that are related to the workflow templates; and
a plurality of workflow template conditions that are related to the workflow templates;
a workflow execution track template registry configured to register:
a plurality of track templates, each track template includes one or more of the workflow templates; and
a plurality of track template conditions that are related to the track templates, the track template conditions include one or more of the workflow template conditions;
a quality control (QC) template registry configured to register a plurality of QC templates that configure a seismic processing data visualization environment, the QC templates are associated with the one or more steps in the workflow templates, which provides an ability to display and review the output seismic data and diagnostic data of the seismic processing step in a standardized manner;
a workflow execution graphical user interface configured to enable a definition of a seismic processing project, the seismic processing project includes a plurality of tracks and a sequence of seismic processing activities to achieve an end objective, and the tracks are created based upon the track templates and the track template conditions,
a workflow execution dispatcher configured to cause one or more of the steps to interact with a cloud computing environment; and
an output data registry, computational processes that are configured by the workflow steps to execute in locations on the cloud computing environment communicate the output seismic data by registering the locations in the output data registry.

12. The computing system of claim 11, wherein each track provides a selection of the workflow templates that have been registered with the workflow template registry, and only the workflow templates in which the track template conditions are met are provided in the selection.

13. The computing system of claim 11, wherein a successful execution of a first workflow step in one or more of the workflow templates automatically triggers an execution of a second workflow step in the one or more of the workflow templates.

14. The computing system of claim 11, wherein a successful execution of a first of the one or more workflow templates within one or more of the track templates automatically triggers an execution of a second of the one or more workflow templates within one or more of the track templates.

15. The computing system of claim 11, comprising a wellsite action module that is configured to generate or transmit a signal that causes a wellsite action to take place at a wellsite in response to the output seismic data.

16. A computing system for providing standardized seismic processing workflows, comprising:
a workflow template registry configured to register:
a plurality of workflow templates that each include one or more steps, the one or more steps include a seismic processing step that produces output seismic data, the workflow templates include defined antecedent or subsequent workflow templates, and the workflow templates include tomography, full waveform inversion (FWI), or both;
a plurality of parameters that are related to the workflow templates, the parameters include input data locations, output data locations, and geophysical algorithm parameters; and
a plurality of workflow template conditions that are related to the workflow templates, the workflow template conditions include a geological setting, a seismic processing project objective, a seismic processing project data type, and a seismic processing project work scope;
a workflow execution track template registry configured to register:
a plurality of track templates, each track template includes one or more of the workflow templates; and
a plurality of track template conditions that are related to the track templates, the track template conditions include the geological setting, the seismic processing project objective, the seismic processing project data type, and the seismic processing project work scope;
a quality control (QC) template registry configured to register a plurality of QC templates that configure a seismic processing data visualization environment,
the QC templates are associated with the one or more steps in the workflow templates, which provides an ability to display and review the output seismic data and diagnostic data of the seismic processing step in a standardized manner;
a workflow execution graphical user interface configured to enable a definition of a seismic processing project,
the seismic processing project includes a plurality of tracks and a sequence of seismic processing activities to achieve an end objective,
the tracks are created based upon the track templates and the track template conditions,
each track provides a selection of the workflow templates that have been registered with the workflow template registry and created in a context of the respective track,
only the workflow templates in which the track template conditions are met are provided in the selection,
the QC templates configure the workflow execution graphical user interface to present one or more data visualization interfaces,
the workflow execution graphical user interface supports viewing the output seismic data in the one or more data visualization interfaces,
the workflow execution graphical user interface provides recommendations on the parameters based on displays configured in the QC templates, and
the output seismic data from a first step of the one or more steps or the parameters from the first step in one or more of the workflow templates are configured to be automatically configured as the parameters for a subsequent step of the one or more steps in the same workflow template as defined by the workflow templates;
a workflow execution dispatcher configured to cause one or more of the steps to interact with one or more cloud computing environments,
one or more interfaces and protocols facilitate data to be communicated between the one or more cloud computing environments and the workflow execution graphical user interface,
a successful execution of a first workflow step in one or more of the workflow templates automatically triggers an execution of a second workflow step in the one or more of the workflow templates, and
the successful execution of a first of the one or more workflow templates within one or more of the track templates automatically triggers an execution of a second of the one or more workflow templates within one or more of the track templates; and
an output data registry,
computational processes that are configured by the workflow steps to execute in locations on the one or more cloud computing environments communicate the output seismic data by registering the locations in the output data registry, and
standardized identifiers are used to correlate the output seismic data to the parameters or the input data locations used in the seismic processing data visualization environment via configuration in one or more of the QC templates, or for use in subsequent workflow steps configured in one or more of the workflow templates.

17. The medium of claim 16, wherein the seismic processing project includes a customer name, a project name, an accounting code, the geological setting, the seismic processing project objective, the seismic processing project data type, and the seismic processing project work scope.

18. The medium of claim 16, wherein the one or more data visualization interfaces display 2D seismic data and model data and 3D seismic data and model, well data, geological data, charts and graphs of data related to a performance or a quality of the seismic processing step, and geographical maps displaying data associated with the seismic processing step.

19. The medium of claim 16, wherein the data communicated between the cloud computing environment and the workflow execution graphical user interface includes error or success conditions of an execution of one or more of the steps of the workflow templates, locations of the output seismic data, diagnostic information on a computational efficiency, diagnostic information on computational failures, a cost of the workflow step, and a convergence metric.

20. The medium of claim 16, comprising a wellsite action module that is configured to generate or transmit a signal that causes a physical action to take place at a wellsite in response to the output seismic data.
